(19) United States
(12) Patent Application Publication
(10) Pub. No.: US 2022/0232595 A1
(43) Pub. Date: Jul. 21, 2022

(54) METHOD OF INTERLACED PUCCH DESIGN-FORMAT 1

(71) Applicant: OROPE FRANCE SARL, Neuilly sur Seine (FR)

(72) Inventor: Hao LIN, Neuilly sur Seine (FR)

(73) Assignee: OROPE FRANCE SARL, Neuilly sur Seine (FR)

(21) Appl. No.: 17/712,762

(22) Filed: Apr. 4, 2022

Related U.S. Application Data
(63) Continuation of application No. PCT/IB2019/001269, filed on Oct. 5, 2019.

(51) Int. Cl. H04W 72/12; H04L 27/26; H04W 16/14

(52) U.S. Cl. CPC H04W 72/1268; H04W 16/14; H04W 72/1205; H04L 27/2601

(57) ABSTRACT

The disclosure is related to a method of generating a physical uplink control channel (PUCCH) in unlicensed spectrum, which is transmitted by a user equipment, the method comprising: generating a PUCCH format 1 in an interlaced structure by: determining a cyclic shift group (CSG) containing a first cyclic shift member (CSMf) and a plurality of subsequent cyclic shift members (CSMn), each cyclic shift member (CSM) being defined at least by a value and a position, by: configuring the first cyclic shift member (CSMf) with a first indication related to the CSMf value and a second indication related to the CSMf position; deriving the plurality of subsequent cyclic shift members (CSMn) based on the CSMf value and on the relative position between CSMf and each CSMn so as to define all CSM which are mutually different.

### CROSS-REFERENCE TO RELATED APPLICATIONS

This application is a continuation of International Application No. PCT/IB2019/001269, filed on Oct. 5, 2019, the disclosure of which is hereby incorporated by reference in its entirety.

### TECHNICAL FIELD

The present disclosure relates to the field of communication technologies in unlicensed spectrum, and in particular, to a method for a user equipment to transmit a physical uplink control channel in a wireless communication system supporting an unlicensed band and apparatuses supporting the same.

The communication technology is for example a 5G (fifth generation) network using the 5G NR (New Radio) as radio access technology (RAT) defined by 3GPP. The present disclosure is applicable to 5G NR-U (NR in unlicensed spectrum).

### BACKGROUND

According to the NR specification Release 15 (NR R15, 3GPP TS 38.213), the user equipment (UE) reports uplink control information (UCI) in a physical uplink control channel (PUCCH).

PUCCH Format 0

In NR Rel. 15, the PUCCH format 0 is generated from a specified computer generated sequence (CGS) of length 12, i.e., S(n),n=0, . . . , 11, which possesses very low

Peak-to-Average Power Ratio (PAPR) property. This channel can carry 1 or 2-bits ACK/NACK (A/N) information together with Scheduling Request (SR) indication. The A/N information is presented by the cyclic shift (CS), additionally introduced on top of the CGS. There are 12 possible CS, i.e. m=0, . . . , 11. The cyclic shifted sequence is given by

$${S}_{c s} ( n ) = {e}^{\frac{j π}{6} α n} \cdot S ( n ) , n = 0 , . . . , 11 ,$$

where α is a phase rotation depending on the selected CS m_{cs}. The A/N information is tightly bounded with the m value, which is specified in NR Rel. 15, TS 38.213 section 9.2.3 and section 9.2.5.1. The PUCCH format 0 occupies 1 Physical Resource Block (PRB) in frequency (12 subcarriers) and 1 or 2 orthogonal frequency-division multiplexing (OFDM) symbols in time domain.

PUCCH Format 1

The PUCCH format 1 is an extension of format 0 in a way that the format 1 spreads the format 0 over multiple OFDM symbols (4 or more) as presented in NR Rel. 15, TS 38.213 section 9.2.2 and section 9.2.5.2. Moreover the DeModulation Reference Signals (DMRS) are alternated with the control sequence such as shown in FIG. 2, where one slot is used for a control signal and the next slot is used for a reference signal, etc.

NR-U PUCCH Interlace

In the unlicensed band in 5G Hz, the regulation imposes that if a transmitter wants to operate transmission in the channel, the transmission has to occupy at least 80% of the channel bandwidth. With this restriction in mind, NR-U decided to adopt an interlaced structure for two uplink channel transmissions, they are PUCCH and PUSCH. Each interlace structure will have specific number of PRB. Between each consecutive PRB pairs, there is M PRB further apart. For example, in a 20 Mhz bandwidth and for 30 Khz subcarrier spacing case, 1 interlace has 10 or 11 PRBs and M=5 as shown in FIG. 1.

The NR Rel.15 PUCCH format 1 occupies only 1 PRB in frequency domain, while in NR-U the interlaced structure has to be implemented. A simple repetition of NR Rel. 15 PUCCH format 1 in each of the PRBs of an interlace will cause very high PAPR issue. Thus, an enhancement should be done for this new design of PUCCH format 1 in NR-U systems.

### SUMMARY

A first object of the present disclosure is a method of generating a physical uplink control channel (PUCCH) in unlicensed spectrum, which is transmitted by a user equipment, the method comprising:
generating a PUCCH format 1 in an interlaced structure by:
   determining a cyclic shift group (CSG) containing a first cyclic shift member (CSMf) and a plurality of subsequent cyclic shift members (CSMn), each cyclic shift member (CSM) being defined at least by a value and a position, by:
      configuring the first cyclic shift member (CSMf) with a first indication related to the CSMf value and a second indication related to the CSMf position;
      deriving the plurality of subsequent cyclic shift members (CSMn) based on the CSMf value and on the relative position between CSMf and each CSMn so as to define all CSM which are mutually different;
   determining a first control sequence (S_{cs}ⁱ(n)), in one OFDM symbol within OFDM symbols allocated for control sequence, by a first base sequence (S(n)), an acknowledgment information symbol (b) and the cyclic shift group;
   determining a first reference sequence (R_{cs}ⁱ(n)), in one OFDM symbol within all OFDM symbols allocated for reference sequence, by the first base sequence (S(n)) and the cyclic shift group.

Such method allows to generate a PUCCH format 1 in the interlaced structure that is able to carrier 1-bit, 2-bit A/N. Moreover this method allows to maintain a low PAPR property. The first and second indications may be assigned to different user equipments (UE) in order to enable UE multiplexing in the same resource, i.e. different UEs will be assigned to different first cyclic shift member, and/or different first cyclic shift member position.

Advantageously, the acknowledgment information (A/N) symbol is a complex-valued symbol (b), BPSK for 1-bit A/N or QPSK for 2-bit A/N.

Advantageously, the first control sequence is obtained by:

$${S}_{c s}^{i} ( n ) = {e}^{\frac{j π}{6} {m}_{c s}^{i} n} \cdot b \cdot S ( n ) ,$$

where S(n) is the base sequence and b is acknowledgment information (A/N) symbol.

Advantageously, the first reference sequence is obtained by:

$${R}_{c s}^{i} ( n ) = {e}^{\frac{j π}{6} {m}_{c s}^{i} n} \cdot S ( n ) .$$

Advantageously, the cyclic shift group (CSG) includes Scheduling Request (SR) information.

Such method allows to design a PUCCH format 1 including the SR indication which can be used to obtain mutually different CSM.

Advantageously, the method comprises:
spreading the first control sequence (S_{cs}ⁱ(n)) over the OFDM symbols allocated for control sequence; and
spreading the first reference sequence (R_{cs}ⁱ(n)) over the OFDM symbols allocated for reference sequence.

Advantageously, the first control sequence spreading is given by:

S_{cs}^{i,j}(n)=S_{cs}ⁱ(n)·w(j),

where w(j) is a first orthogonal sequence and for which the generated PUCCH format 1 contains m OFDM symbols for the first control sequence spreading;

and wherein first reference sequence spreading is given by:

R_{cs}(n)=R_{cs}ⁱ(n)·w′ (j),

where w′(j) is the second orthogonal sequence and for which the generated PUCCH format 1 contains l OFDM symbols for the first reference sequence spreading.

Advantageously, the first indication is either a direct indication of the CSMf value from a set of CSM candidates or an indirect indication by a first offset with respect to a reference value of the CSMf in a set of ordered CSM candidates. More preferably, in case of an indirect indication, the reference value of the CSMf is either pre-defined or configured via a radio resource control (RRC) or derived by a first function. Advantageously, a default CSMf value is set in the absence of a first indication.

Such first indication (direct, indirect or by default) allows to determine the value of CSMf and derive the subsequent values of CSMn.

Advantageously, the second indication is either a direct indication of the CSMf position in the CSG from a set of position candidates or an indirect indication by a second offset with respect to a reference position of the CSMf in a set of ordered position candidates. More preferably, in case of an indirect indication, the reference position of the CSMf is either pre-defined or configured via a radio resource control (RRC) or derived by a second function. Advantageously, a default CSMf position is set in the absence of a second indication.

Such second indication (direct, indirect or by default) allows to determine the position of CSMf and derive the subsequent position of CSMn.

Advantageously, subsequent CSMn values are derived using a third function including at least one parameter T determined by a third indication. More preferably, the third indication is either a direct indication of the parameter value from a set of parameter value candidates or a default value in the absence of the third indication.

The first, second and third indications may be assigned to different UEs in order to enable UE multiplexing in the same resource, i.e. different UEs will be assigned to different first cyclic shift member, and/or different first cyclic shift member position, and/or different T. Thus, the third indication allows to further reduce the PAPR issues.

Advantageously, the plurality of subsequent cyclic shift members (CSMn) is derived in a way such that CSMn and the CSMf have the following relationship:

m_{cs}^{j}=(m_{cs}ⁱ+((j−i)mod N_{RB}^{interlace})T)mod 12.

A second object of the present disclosure is a user equipment transmitting a physical uplink control channel to a base station in a wireless communication system in unlicensed spectrum, the user equipment comprising:

a processor configured to generate a PUCCH format 1 in an interlaced structure by:
determining a cyclic shift group (CSG) containing a first cyclic shift member (CSMf) and a plurality of subsequent cyclic shift members (CSMn), each cyclic shift member (CSM) being defined at least by a value and a position, by:
   configuring the first cyclic shift member (CSMf) with a first indication related to the CSMf value and a second indication related to the CSMf position;
   deriving the plurality of subsequent cyclic shift members (CSMn) based on the CSMf value and on the relative position between CSMf and each CSMn so as to define all CSM which are mutually different;
determining a first control sequence (S_{cs}ⁱ(n)), in one OFDM symbol within OFDM symbols allocated for control sequence, by a first base sequence (S(n)), an acknowledgment information symbol (b) and the cyclic shift group;
determining a first reference sequence (R_{cs}ⁱ(n)), in one OFDM symbol within all OFDM symbols allocated for reference sequence, by the first base sequence (S(n)) and the cyclic shift group.

Advantageously, the processor is configured to generate the PUCCH format 1 according to any of the advantageous aspects of the first object.

A third object of the present disclosure is a computer readable medium comprising program instructions for causing a user equipment to perform the steps of the transmitting method according to the first object.

### BRIEF DESCRIPTION OF DRAWINGS

The appended drawings required in description of embodiments or the prior art will be briefly described below.

FIG. 1 shows an example of an interlaced structure for PUCCH;

FIG. 2 shows an example of reference signal alternated with a control signal;

FIG. 3 shows an example of a cyclic shift group (CSG) within 1 interlace;

FIG. 4 shows another example of a cyclic shift group (CSG) within 1 interlace;

FIG. 5 shows another example of a cyclic shift group (CSG) within 1 interlace;

FIG. 6 shows another example of a cyclic shift group (CSG) within 1 interlace;

FIG. 7 shows another example of a cyclic shift group (CSG) within 1 interlace.

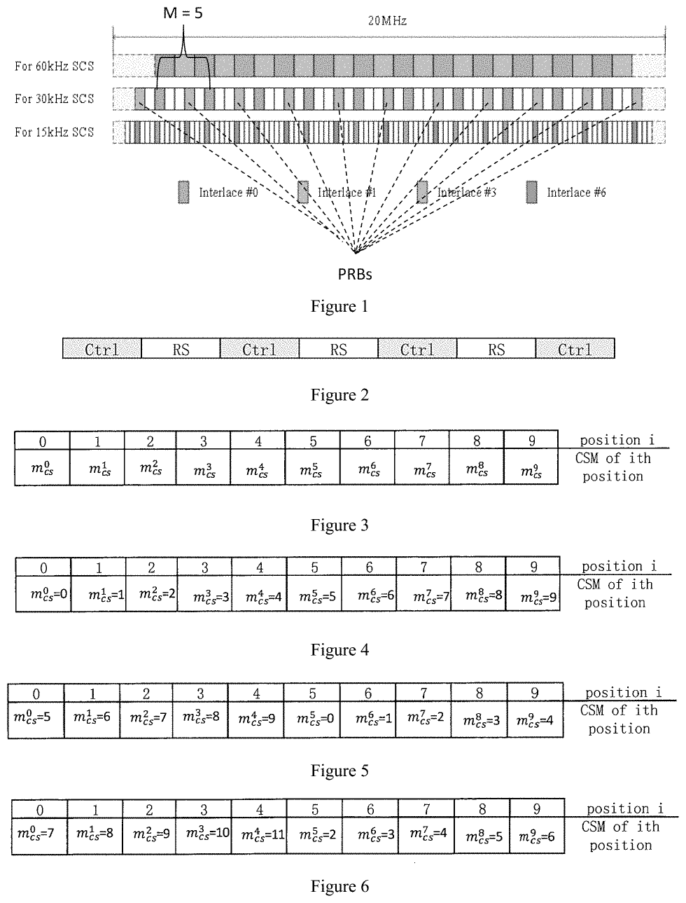

### DESCRIPTION OF EMBODIMENTS

In the following disclosure, we will first present a cycle shift group and cycle shift member, followed by examples for implementing a method of generating a PUCCH format 1.

Cycle Shift Group and Cycle Shift Members

The cyclic shift group (CSG) can be expressed as m_{cs}ⁱ with i=0, . . . , N_{RB}^{interlace}−1, where N_{RB}^{interlace} stands for the total number of PRB within 1 interlace; m_{cs}ⁱ is a cyclic shift member and its corresponding position is i-th position within the cyclic shift group. Thus a cyclic shift group contains N_{RB}^{interlace} cyclic shift members and accordingly it contains N_{RB}^{interlace} positions. In the example of FIG. 3, we assume N_{RB}^{interlace}=10. Therefore, the position i goes from 0 up to 9.

If one cyclic shift member as well as its position are determined (i.e. m_{cs}ⁱ), the cyclic shift member on the rest of the positions (i.e. m_{cs}^{j}) can be derived from some pre-defined relationship, such as:

m_{cs}^{j}=(m_{cs}ⁱ+((j−i)mod N_{RB}^{interlace})T)mod 12.

In this example, all cyclic shift members on j-th position, m_{cs}^{j}, can be derived from m_{c}ⁱₛ and the relative position between j and i, and optionally with a parameter T. Here m_{cs}ⁱ is the value of the so-called first cycle shift member (CSMf), to be indicated by a first indication, i is the position of CSMf, to be indicated by a second indication, and T is an optional first parameter to be indicated by a third indication.

Cycle Shift Member Candidates and Generation of PUCCH Format 1

In the present disclosure, we assume that the cyclic shift member (CSM) can take the value from a set of candidate values, called cyclic shift member candidates. The candidate values are integer values from 0 up to 11, i.e. {0,1,2,3,4,5,6,7,8,9,10,11}. The re a son of this choice is that after the cyclic shift group is decided, the PUCCH format 1 is generated as follows.

In this example, the reference parameters m_{cs}^{ref}, p^{ref}, t^{ref}, have a fixed or configured initial values. Thus, when the UE receives the offset₁, offset₂, offset₃, the UE can obtain the first control sequence such as:

$${S}_{c s}^{i} ( n ) = {e}^{\frac{j π}{6} {m}_{c s}^{i} n} \cdot b \cdot S ( n ) , n = 0 , . . . , 11 ; i = 0 , . . . , {N}_{R B}^{interlace} - 1 ,$$

where S(n) is a base sequence and b is a complex-valued symbol, BPSK for 1-bit A/N or QPSK for 2-bit A/N.

Then, the first control sequence spreading is given by:

S_{cs}^{i,j}(n)=S_{cs}ⁱ(n)·w(j), n=0, . . . , 11; i=0, . . . , N_{RB}^{interlace}−1,j=0, . . . m−1,

where, w(j) is the first orthogonal sequence and we assume that have a PUCCH format 1 which contains m OFDM symbols for first control sequence spreading.

The first reference sequence is obtained by:

$${R}_{c s}^{i} ( n ) = {e}^{\frac{j π}{6} {m}_{c s}^{i} n} \cdot S ( n ) , n = 0 , . . . , 11 ; i = 0 , . . . , {N}_{R B}^{interlace} - 1 .$$

Then the first reference sequence spreading is:

R_{cs}^{i,j}(n)=R_{cs}ⁱ(n)·w′(j), n=0, . . . , 11; i=0, . . . , N_{RB}^{interlace}−1, j=0, . . . l−1

where, w′(j) is the second orthogonal sequence and we assume that have a PUCCH format 1 which contains l OFDM symbols for first reference sequence spreading.

### Examples of Determination of the Cycle Shift Group

For example, if we assume that N_{RB}^{interlace}=10, and T=1, when one cyclic shift member (CSM) value and its corresponding position is given, for example m_{cs}⁰=0 , then we can derive m_{cs}^{j}=(0+j mod 10)mod 12={1,2,3,4,5,6,7,8,9} for j={1,2,3,4,5,6,7,8,9}, respectively. Thus, the cyclic shift group CSG is m_{cs}ⁱ=i, for i={0,1,2,3,4,5,6,7,8,9} as shown in FIG. 4.

In this example, the first cyclic shift member CSMf (a.k.a. m_{cs}), for which the cyclic shift member value is indicated by the first indication and its position is indicated by the second indication, i.e. m_{cs}⁰=0. The rest of the cyclic shift members (CSMn) in the group can be derived from a pre-defined relationship, which is m_{cs}^{j}=(m_{cs}⁰+((j−0)mod 10)T)mod 12. Then the third indication will give the value of the parameter T, i.e. T=1 in our example.

Another example, if we set one cyclic shift member and its corresponding position to m_{cs}⁵=0, then we can derive m_{cs}^{j}=(0+(j−5)mod 10)mod 12={5,6,7,8,9,1,2,3,4} for j={0,1,2,3,4,6,7,8,9}, respectively. Thus, the cyclic shift group is {5,6,7,8,9,0,1,2,3,4} as shown in FIG. 5.

In this example, the first cyclic shift member CSMf (a.k.a. m_{cs}), for which the cyclic shift member value is indicated by the first indication and its position is indicated by the second indication, i.e. m_{cs}⁵=0. The rest of the cyclic shift members in the group can be derived from a pre-defined relationship, which is m_{cs}^{j}=(m_{cs}⁵((j−5)mod 10)T)mod 12. Then the third indication will give the value of the parameter T, i.e. T=1 in our example.

CSG Determination with Offset Indications

Coming back to the CSG determination, the network, e.g. a base station, can send the first and second indications to inform the UE about the first cyclic shift member and its corresponding position. For example, the first indication can be an offset w.r.t. m_{cs}^{ref}, e.g. offset₁=2; and the second indication can point directly to the position index, such as 5. In this manner, the UE knows that the first cyclic shift member is m_{cs}⁵=m_{cs}^{ref}+offset₁=2.

As long as the first cyclic shift member is determined, all the subsequent members can be derived from it when the derivation relationship is determined, which can be optionally depending on a the third indication. Assume that the third indication points the parameter T=1, then we have the following derivation relationship:

m_{cs}^{j}=(m_{cs}⁵+((j−5)mod 10))mod 12.

As a result the cycle shift group determined is given in FIG. 6.

It is worth noting that the second and the third indications can also indicate an offset w.r.t. a pre-defined reference. For instance, for the second indication, the network can define a reference position, e.g., p^{ref}=0, then the indication gives an offset . Thus, the UE will understand that the indicated position is p=p^{ref}+offset₂, where offset₂={0,1,2,3,4,5,6,7,8,9}.

Similarly, the third indication can also give an offset₃ within a set of candidate values w.r.t. a pre-defined value, e.g. T=A (t^{ref}+offset₃). Assuming the candidate values are {1,3,5,7,11} and t^{ref}=0. Then the third indication can indicate: offset₃={0,1,2,3,4}. Either ways, i.e. direct indication or indirect indication via reference and offsets, will lead to the same cyclic shift group.

### Examples of CSG with Scheduling Request (SR)

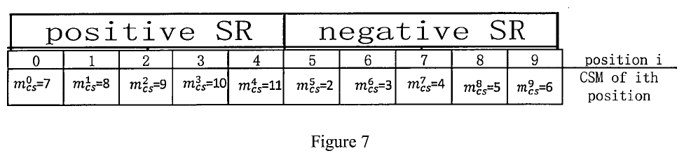

In a more complex example, the UE has to report positive SR or negative SR. The reference cyclic shift member value can be used to reflect positive and negative SR. An example is shown in FIG. 7 where reference values are pre-defined:

positive SR: m_{cs}ⁱ=k, where i={0,1,2,3,4} and k={7,8,9,10,11};

negative SR: m_{cs}ⁱ=k, where i={5,6,7,8,9} and k={2,3,4,5,6}.

Alternatively, to include SR, we can also set the reference cyclic shift member value m_{cs}^{ref} and/or the reference position p^{ref} and/or the reference parameter t^{ref} to represent SR. For example, p^{ref}=0 is used for a positive SR and p^{ref}=5 is used for a negative SR. Another example, t^{ref}=1 is used for a positive SR and t^{ref}=7 is used for a negative SR. Another example, m_{cs}^{ref}=0 is used for a positive SR and m_{cs}^{ref}=6 is used for a negative SR. Any combination is also possible.

### Example of UE Multiplexing

In the above examples, the reference cyclic shift member, m_{cs}^{ref}, may represent SR results, while the first, second and third indications are assigned to different UEs in order to enable UE multiplexing in the same resource, i.e. different UEs will be assigned to different first cyclic shift member, and/or different first cyclic shift member position, and/or different T.

### LIST OF ABBREVIATIONS IN THE DESCRIPTION AND DRAWINGS

| Acronyms | Full name |
|---|---|
| LTE | Long Term Evolution |
| LTE-A | Advanced long term evolution |
| NR | New Radio |
| NR-U | New Radio-unlicensed |
| BS | Base-station |
| UE | User Equipment |
| PUCCH | Physical Uplink Control CHannel |
| PUSCH | Physical Uplink Shared CHannel |
| UCI | UPlink control information |
| LBT | Listen Before Talk |
| SR | Scheduling Request |
| CSM | Cyclic Shift Member |
| CSMf | first Cyclic Shift Member |
| CSMn | subsequent Cyclic Shift Member |
| CSG | Cyclic Shift Group |
| A/N | ACK/NACK (Acknowledgment/Non-Acknowledgment) |
| OFDM | Orthogonal frequency-division multiplexing |

In the above description, the mobile telecommunication system is a 5G mobile network comprising a 5G NR access network. The present example embodiment is applicable to NR in unlicensed spectrum (NR-U). The present disclosure can be applied to other mobile networks, in particular to mobile network of any further generation cellular network technology (6G, etc.).

The above is only a specific implementation manner of the present disclosure, the protection scope of the present disclosure is not limited thereto, and changes or substitutions that can easily be thought of by those skilled in the art within the technical scope disclosed in the present disclosure should be covered by the protection scope of the present disclosure. Therefore, the protection scope of the present disclosure should be subject to the protection scope of the claims.

The various embodiments/examples, aspects and features, if any, described in this specification that do not fall under the scope of the independent claims are to be interpreted as examples useful for understanding various embodiments of the disclosure.

What is claimed is:

1. A method of generating a physical uplink control channel (PUCCH) in unlicensed spectrum, which is transmitted by a user equipment, the method comprising:
generating a PUCCH format 1 in an interlaced structure by:
determining a cyclic shift group (CSG) containing a first cyclic shift member (CSMf) and a plurality of subsequent cyclic shift members (CSMn), each cyclic shift member (CSM) being defined at least by a value and a position, by:
configuring the CSMf with a first indication related to a CSMf value and a second indication related to a CSMf position;
deriving the plurality of CSMn based on the CSMf value and on a relative position between the CSMf and each CSMn so as to define all CSM which are mutually different;
determining a first control sequence (S_{cs}ⁱ(n)), in one orthogonal frequency-division multiplexing (OFDM) symbol within OFDM symbols allocated for control sequence, by a first base sequence (S (n)), an acknowledgment information (A/N) symbol (b) and the CSG;
determining a first reference sequence (R_{cs}ⁱ(n)), in one OFDM symbol within all OFDM symbols allocated for reference sequence, by the first base sequence (S(n)) and the CSG.

2. The method of generating a physical uplink control channel (PUCCH) according to claim 1, wherein the A/N symbol is a complex-valued symbol (b), BPSK for 1-bit A/N or QPSK for 2-bit A/N.

3. The method of generating a physical uplink control channel (PUCCH) according to claim 2, wherein the first control sequence is obtained by:
$${S}_{c s}^{i} ( n ) = {e}^{\frac{j π}{6} {m}_{c s}^{i} n} \cdot b \cdot S ( n )$$
wherein S(n) is the first base sequence and b is the A/N symbol.

4. The method of generating a physical uplink control channel (PUCCH) according to claim 3, wherein the first reference sequence is obtained by:
$${R}_{c s}^{i} ( n ) = {e}^{\frac{j π}{6} {m}_{c s}^{i} n} \cdot S ( n ) .$$

5. The method of generating a physical uplink control channel (PUCCH) according to claim 1, wherein the CSG includes scheduling request (SR) information.

6. The method of generating a physical uplink control channel (PUCCH) according to claim 1, the method comprising:
spreading the first control sequence (S_{cs}^{i,j}(n)) over the OFDM symbols allocated for the control sequence; and
spreading the first reference sequence (R_{cs}^{i,j}(n)) over the OFDM symbols allocated for reference sequence.

7. The method of generating a physical uplink control channel (PUCCH) according to claim 6, wherein the control sequence spreading is given by:
S_{cs}^{i,j}(n)=S_{cs}ⁱ(n)·w(j),
wherein w(j) is a first orthogonal sequence and for which the generated PUCCH format 1 contains m OFDM symbols for the first control sequence spreading;
and wherein the first reference sequence spreading is given by:
R_{cs}(n)=R_{cs}ⁱ(n)·w′ (j),
wherein w′(j) is the second orthogonal sequence and for which the generated PUCCH format 1 contains l OFDM symbols for the first reference sequence spreading.

8. The method of generating a physical uplink control channel (PUCCH) according to claim 1, wherein the first indication is either a direct indication of the CSMf value from a set of CSM candidates or an indirect indication by a first offset with respect to a reference value of the CSMf in a set of ordered CSM candidates.

9. The method of generating a physical uplink control channel (PUCCH) according to claim 8, wherein, in case of an indirect indication, the reference value of the CSMf is either pre-defined or configured via a radio resource control (RRC) or derived by a first function.

10. The method of generating a physical uplink control channel (PUCCH) according to claim 1, wherein a default CSMf value is set in the absence of a first indication.

11. The method of generating a physical uplink control channel (PUCCH) according to claim 1, wherein the second indication is either a direct indication of the CSMf position in the CSG from a set of position candidates or an indirect indication by a second offset with respect to a reference position of the CSMf in a set of ordered position candidates.

12. The method of generating a physical uplink control channel (PUCCH) according to claim 11, wherein, in case of an indirect indication, the reference position of the CSMf is either pre-defined or configured via a radio resource control (RRC) or derived by a second function.

13. The method of generating a physical uplink control channel (PUCCH) according to claim 1, wherein a default CSMf position is set in the absence of a second indication.

14. The method of generating a physical uplink control channel (PUCCH) according to claim 1, wherein subsequent CSMn values are derived using a third function including at least one parameter T determined by a third indication.

15. The method of generating a physical uplink control channel (PUCCH) according to claim 14, wherein the third indication is either a direct indication of the parameter value from a set of parameter value candidates or a default value in the absence of the third indication.

16. The method of generating a physical uplink control channel (PUCCH) according to claim 14, wherein the plurality of CSMn is derived from the CSMf based on a pre-defined relationship:
m_{cs}^{j}=(m_{cs}ⁱ+((j−i)mod N_{RB}^{interlace})T)mod 12.

17. The method of generating a physical uplink control channel (PUCCH) according to claim 15, wherein the plurality of CSMn is derived from the CSMf based on a pre-defined relationship:
m_{cs}^{j}=(m_{cs}ⁱ+((j−i)mod N_{RB}^{interlace})T)mod 12.

18. A user equipment transmitting a physical uplink control channel PUCCH to a base station in a wireless communication system in unlicensed spectrum, the user equipment comprising:
a processor configured to generate a PUCCH format 1 in an interlaced structure by:
determining a cyclic shift group (CSG) containing a first cyclic shift member (CSMf) and a plurality of subsequent cyclic shift members (CSMn), each cyclic shift member (CSM) being defined at least by a value and a position, by:
configuring the CSMf with a first indication related to a CSMf value and a second indication related to a CSMf position;
deriving the plurality of CSMn based on the CSMf value and on a relative position between the CSMf and each CSMn so as to define all CSM which are mutually different;
determining a first control sequence (S_{cs}ⁱ(n)), in one orthogonal frequency-division multiplexing (OFDM) symbol within OFDM symbols allocated for control sequence, by a first base sequence (S(n)), an acknowledgment information (A/N) symbol (b) and the CSG;
determining a first reference sequence (R_{cs}ⁱ(n)), in one OFDM symbol within all OFDM symbols allocated for reference sequence, by the first base sequence (S(n)) and the CSG.

19. The user equipment according to claim 18, wherein the A/N symbol is a complex-valued symbol (b), BPSK for 1-bit A/N or QPSK for 2-bit A/N.

20. A non-transitory computer readable medium comprising program instructions for causing a user equipment to:
generate a PUCCH format 1 in an interlaced structure by:
determining a cyclic shift group (CSG) containing a first cyclic shift member (CSMf) and a plurality of subsequent cyclic shift members (CSMn), each cyclic shift member (CSM) being defined at least by a value and a position, by:
configuring the CSMf with a first indication related to a CSMf value and a second indication related to a CSMf position;
deriving the plurality of CSMn based on the CSMf value and on a relative position between the CSMf and each CSMn so as to define all CSM which are mutually different;
determining a first control sequence (S_{cs}ⁱ(n)), in one orthogonal frequency-division multiplexing (OFDM) symbol within OFDM symbols allocated for control sequence, by a first base sequence (S(n)), an acknowledgment information (A/N) symbol (b) and the CSG;
determining a first reference sequence (R_{cs}ⁱ(n)), in one OFDM symbol within all OFDM symbols allocated for reference sequence, by the first base sequence (S(n)) and the CSG.
